(19) United States
(12) Patent Application Publication
(10) Pub. No.: US 2026/0371227 A1
(43) Pub. Date: Nov. 19, 2026

(54) CONNECTING TO A WLAN ACCESS NETWORK USING 3GPP-BASED AUTHENTICATION

(71) Applicant: Lenovo (Singapore) Pte. Limited, Singapore (SG)

(72) Inventor: Apostolis Salkintzis, Glika Nera (GR)

(73) Assignee: Lenovo (Singapore) Pte. Limited, Singapore (SG)

(21) Appl. No.: 19/102,134

(22) PCT Filed: Sep. 28, 2022
(86) PCT No.: PCT/EP2022/077070

§ 371 Date: Feb. 7, 2025

(30) Foreign Application Priority Data
Aug. 8, 2022 (GR) 20220100666

(51) Int. Cl. H04W 48/16; H04W 12/06; H04W 84/04

(52) U.S. Cl. CPC H04W 48/16; H04W 12/06; H04W 84/042

(57) ABSTRACT

There is provided a wireless communication device comprising a receiver arranged to receive a network information message, the network information message identifying a list of PLMNs that support Authentication with 5GC using 3GPP 5G credentials.

### FIELD

The subject matter disclosed herein relates generally to the field of implementing connection to a WLAN access network using 3GPP-based authentication. This document defines a wireless communication device, a method in a wireless communication device, a wireless communication network, and a method in a wireless communication network.

### BACKGROUND

3GPP TS 23.402 v17.0.0 specifies the stage 2 service description for providing IP connectivity using non-3GPP accesses to the Evolved 3GPP Packet Switched domain. In addition, for E-UTRAN and non-3GPP accesses, the specification describes the Evolved 3GPP PS Domain where the protocols between its Core Network elements are IETF-based. Clause 4.8.2b states that when the UE has valid 3GPP subscription credentials (i.e. a valid USIM) and WLANSP policies, the UE shall perform WLAN selection based on these policies, the applicable user preferences and the corresponding procedures specified in this document. User preferences take precedence over the WLANSP policies.

3GPP TS 23.502 v17.5.0 describes Stage 2 procedures and Network Function Services for the 5G system architecture and for the policy and charging control framework. Clause 4.12a.2.2 describes 5G registration via trusted non-3GPP access, stating that the UE connects to a trusted non-3GPP Access Network (TNAN) and it also registers to 5GC over via this TNAN, by using the EAP-based procedure. The link between the UE and the TNAN can be any data link (L2) that supports EAP encapsulation, e.g. PPP, PANA, Ethernet, IEEE 802.3, IEEE 802.11, etc. The interface between the TNAP and TNGF is an AAA interface.

3GPP TS 23.501 v17.5.0 describes Stage 2 system architecture for the 5G System, and covers both roaming and non-roaming scenarios in all aspects, including interworking between 5GS and EPS, mobility within 5GS, QoS, policy control and charging, authentication and in general 5G System wide features e.g. SMS, Location Services, Emergency Services. Clause 6.3.12 specifies how a UE, which wants to establish connectivity via trusted non-3GPP access, selects a PLMN and a trusted non-3GPP access network (TNAN) to connect to.

3GPP TS 33.402 v17.0.0 specifies the security architecture, i.e., the security feature groups and the security mechanisms performed during inter working between non-3GPP accesses and the Evolved Packet System (EPS).

### SUMMARY

A problem with exiting methods for connecting to a WLAN access network using 3GPP-based authentication is that a UE may attempt to use an authentication method that is not appropriately supported by the selected WLAN/PLMN combination. Such attempts will fail, resulting in wasted signaling bandwidth and delaying the UE establishing a connection.

Disclosed herein are procedures for connecting to a WLAN access network using 3GPP-based authentication. Said procedures may be implemented by a wireless communication device, a method in a wireless communication device, a wireless communication network, and a method in a wireless communication network.

Accordingly, there is provided a wireless communication device comprising a receiver arranged to receive a network information message, the network information message identifying a list of PLMNs that support Authentication with 5GC using 3GPP 5G credentials.

There is further provided a method in a wireless communication device. The method comprises receiving a network information message, the network information message identifying a list of PLMNs that support Authentication with 5GC using 3GPP 5G credentials.

There is further provided a wireless communication network comprising a transmitter arranged to send a network information message, the network information message comprising a list of PLMNs that support Authentication with 5GC using 3GPP 5G credentials.

There is further provided a method in a wireless communication network, the method comprising sending a network information message, the network information message comprising a list of PLMNs that support Authentication with 5GC using 3GPP 5G credentials.

There is further provided a method in a wireless communication device, the method comprising: receiving a network information message, the network information message identifying a list of PLMNs that support Authentication with 5GC using 3GPP 5G credentials; creating a first list of usable PLMNs, wherein the first list includes the modes of authentication supported by each PLMN in the first list; selecting from the first list of usable PLMNs a first PLMN; creating a second list of available WLAN access networks, wherein the second list includes the modes of authentication supported by each WLAN access network; selecting a first WLAN access network from the second list of available WLAN access networks; and initiating an authentication procedure using the first WLAN access network and the first PLMN, wherein the mode of the authentication procedure is selected dependent upon an authentication capability of the first WLAN access network and the first PLMN.

There is further still provided a wireless communication device comprising a receiver a processor and a transmitter, the wireless communication device arranged to carry out the above-described method.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for connecting to a WLAN access network using 3GPP-based authentication will now be described, byway of example only, with reference to the accompanying drawings, in which:

FIG. 1 depicts an embodiment of a wireless communication system for connecting to a WLAN access network using 3GPP-based authentication;

FIG. 2 illustrates an example deployment scenario of a two UEs connecting to WLAN networks using 3GPP-based authentication;

FIG. 3 depicts a user equipment apparatus;

FIG. 4 depicts a network node;

FIG. 5 illustrates a method in a wireless communication device;

FIG. 6 illustrates a method in a wireless communication network;

FIG. 7 illustrates a further method in a wireless communication device;

FIG. 8 illustrates a problem addressed herein; and

FIG. 9 illustrates a deployment scenario using the network information described herein.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized.

The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

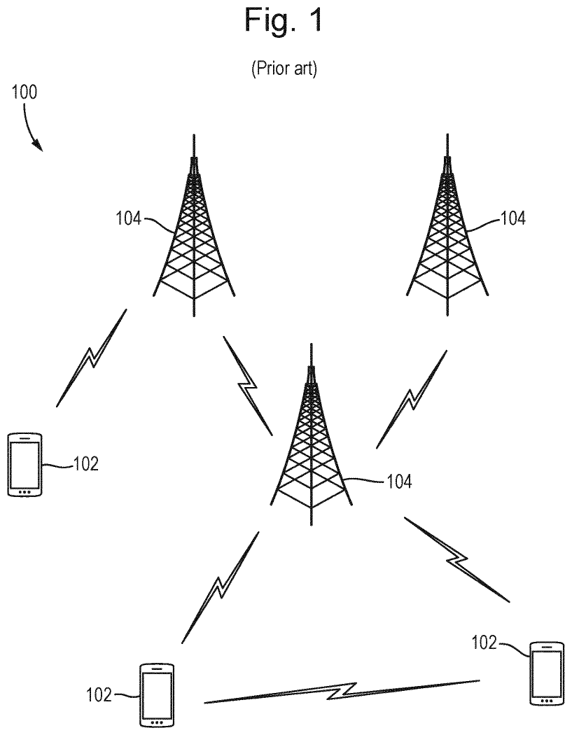

FIG. 1 depicts an embodiment of a wireless communication system 100 for connecting to a WLAN access network using 3GPP-based authentication. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100. The remote unit 102 may be a UE 210, 211, a user equipment apparatus 300, or a UE 814, 815, 910 as described herein. The base unit 104 may be a PLMN 230, a network node 400, or a PLMN 830, 930 as described herein.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

As defined in the 3GPP specifications, a UE is able to connect to a WLAN access network using 3GPP-based authentication and its credentials associated with an Evolved Packet Core (EPC) in a PLMN. The UE can determine the PLMNs with which a WLAN can support 3GPP-based authentication (aka AAA interworking) by requesting and receiving from the WLAN, prior to connection, “3GPP Cellular Network” information. Part of this information indicates the PLMNs with which 3GPP-based authentication is supported by the WLAN.

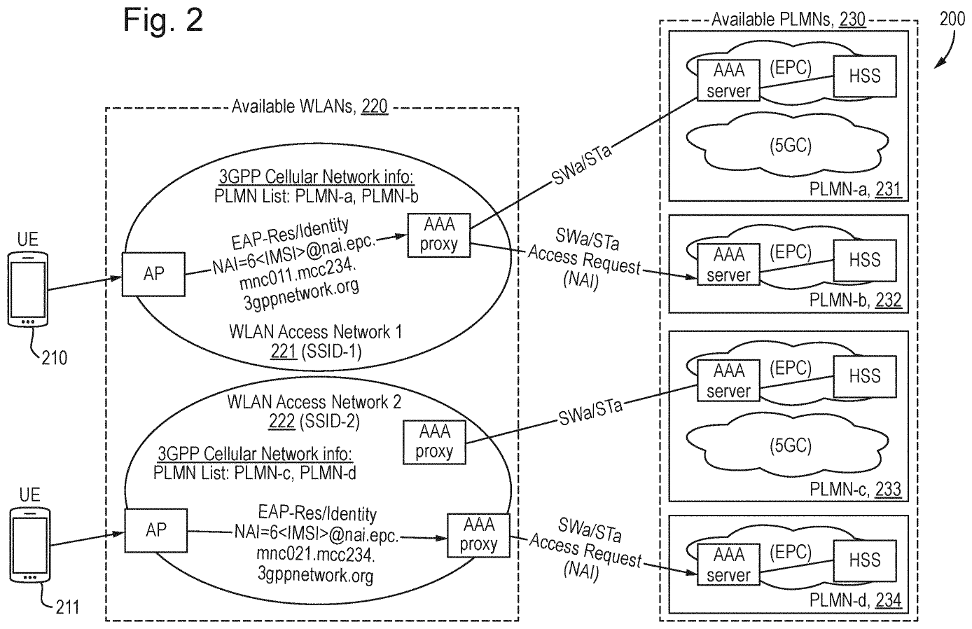

FIG. 2 illustrates an example deployment scenario of a UE 210 and a UE 211 connecting to WLAN networks 220 using 3GPP-based authentication with EPC via a plurality of PLMNs 230. The available WLANs 220 comprise WLAN Access Network 1 221 and WLAN Access Network 2 222. WLAN Access Network 1 221 has a first Service Set IDentifier (SSID), SSID-1. WLAN Access Network 2 222 which has a second SSID, SSID-2. The available PLMNs 230 comprise PLMN-a 231, PLMN-b 232, PLMN-c 233 and PLMN-d 234.

UE 210 receives a PLMN List from WLAN access network 1, 221. The UE 210 can determine from the PLMN List provided by the WLAN access network 221 with SSID-1 (as part of the “3GPP Cellular Network” information), that this access network supports 3GPP-based authentication (or “AAA interworking”) with PLMN-a 231 and PLMN-b 232. If the UE 210 holds EPC/4G credentials for one of these PLMNs, the UE 210 may attempt to connect to WLAN access network 221 having SSID-1 using these credentials. This is achieved by initiating the EAP-AKA′ authentication procedure specified in TS 33.402 v17.0.0, clause 6.2, “Authentication and key agreement for trusted access”. The UE 210 sends a Network Access Identifier (NAI) to WLAN access network 221 having SSID-1 that contains a username equal to its IMSI and a realm containing the identity of the PLMN, which should be used for authenticating and authorizing the UE 210 to connect to the WLAN 221.

In summary, UE 210 determines, based on the received PLMN List provided by WLAN access network 221 having SSID-1, that the WLAN access network 221 having SSID-1 supports AAA interworking with EPC in PLMN-a 231 and PLMN-b 232. The UE 210 may decide to connect to WLAN access network 221 having SSID-1 using 3GPP-based authentication with PLMN-a 231 or PLMN-b 232.

Similarly, another UE 211 can determine from the PLMN List provided by the WLAN access network 222 with SSID-2 (as part of the “3GPP Cellular Network” information), that this access network supports 3GPP-based authentication (or “AAA interworking”) with PLMN-c 233 and PLMN-d 234. If the UE 211 holds EPC/4G credentials for one of these PLMNs, the UE 211 may attempt to connect to WLAN access network 222 having SSID-2 using these credentials.

In summary, UE 211 determines, based on the received PLMN List provided by the WLAN access network 222 with SSID-2, that the WLAN access network 222 with SSID-2 supports AAA interworking with EPC in PLMN-c 233 and PLMN-d 234. The UE 211 may decide to connect to the WLAN access network 222 with SSID-2 using 3GPP-authentication with PLMN-c 233 or PLMN-d 234.

Note that the PLMN List provided by the WLAN access network contains only the list of PLMNs with which AAA interworking is supported. It does not indicate whether the AAA interworking is supported with the EPC or with the 5GC in each of these PLMNs. This has not been a problem until Rel-16 because AAA interworking was supported only with EPC, so it was implicitly assumed that each PLMN in the PLMN List supported AAA interworking with EPC. However, things changed in Rel-17 as a new solution was introduced in the specifications, which enabled support of AAA interworking between WLAN access networks and 5GC. This solution is commonly referred to as 5G “Non-Seamless WLAN offload” (NSWO) and it is specified in 3GPP TS 33.501 v17.6.0, Annex S. The introduction of this solution made it unclear whether each PLMN in the PLMN List supports AAA interworking with EPC and/or with 5GC.

The present application presents a solution to this problem.

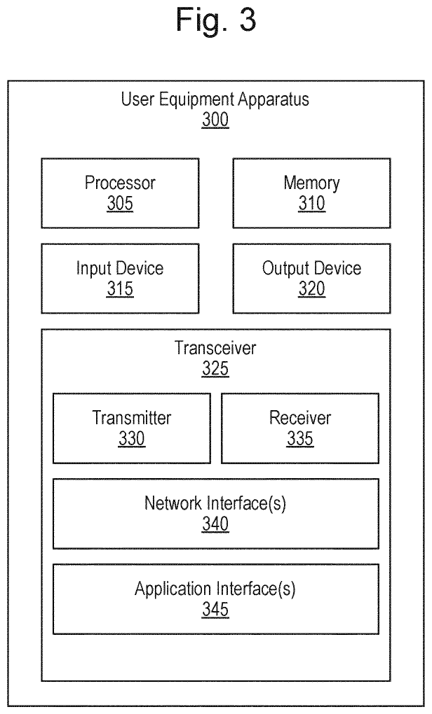

FIG. 3 depicts a user equipment apparatus 300 that may be used for implementing the methods described herein. The user equipment apparatus 300 is used to implement one or more of the solutions described herein. The user equipment apparatus 300 is in accordance with one or more of the user equipment apparatuses described in embodiments herein. The user equipment apparatus 300 may be remote unit 102, a UE 210, 211, or a UE 814, 815, 910 as described herein. The user equipment apparatus 300 includes a processor 305, a memory 310, an input device 315, an output device 320, and a transceiver 325.

The input device 315 and the output device 320 may be combined into a single device, such as a touchscreen. In some implementations, the user equipment apparatus 300 does not include any input device 315 and/or output device 320. The user equipment apparatus 300 may include one or more of: the processor 305, the memory 310, and the transceiver 325, and may not include the input device 315 and/or the output device 320.

As depicted, the transceiver 325 includes at least one transmitter 330 and at least one receiver 335. The transceiver 325 may communicate with one or more cells (or wireless coverage areas) supported by one or more base units. The transceiver 325 may be operable on unlicensed spectrum. Moreover, the transceiver 325 may include multiple UE panels supporting one or more beams. Additionally, the transceiver 325 may support at least one network interface 340 and/or application interface 345. The application interface(s) 345 may support one or more APIs. The network interface(s) 340 may support 3GPP reference points, such as Uu, N1, PC5, etc. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a central processing unit (“CPU”), a graphics processing unit (“GPU”), an auxiliary processing unit, a field programmable gate array (“FPGA”), or similar programmable controller. The processor 305 may execute instructions stored in the memory 310 to perform the methods and routines described herein. The processor 305 is communicatively coupled to the memory 310, the input device 315, the output device 320, and the transceiver 325.

The processor 305 may control the user equipment apparatus 300 to implement the user equipment apparatus behaviors described herein. The processor 305 may include an application processor (also known as “main processor”) which manages application-domain and operating system (“OS”) functions and a baseband processor (also known as “baseband radio processor”) which manages radio functions.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to implement a traffic category field as described herein. The memory 310 may also store program code and related data, such as an operating system or other controller algorithms operating on the apparatus 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 320 may include a wearable display separate from, but communicatively coupled to, the rest of the user equipment apparatus 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound.

For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display.

The output device 320 may be located near the input device 315.

The transceiver 325 communicates with one or more network functions of a mobile communication network via one or more access networks. The transceiver 325 operates under the control of the processor 305 to transmit messages, data, and other signals and also to receive messages, data, and other signals. For example, the processor 305 may selectively activate the transceiver 325 (or portions thereof) at particular times in order to send and receive messages.

The transceiver 325 includes at least one transmitter 330 and at least one receiver 335. The one or more transmitters 330 may be used to provide uplink communication signals to a base unit of a wireless communications network. Similarly, the one or more receivers 335 may be used to receive downlink communication signals from the base unit. Although only one transmitter 330 and one receiver 335 are illustrated, the user equipment apparatus 300 may have any suitable number of transmitters 330 and receivers 335. Further, the transmitter(s) 330 and the receiver(s) 335 may be any suitable type of transmitters and receivers. The transceiver 325 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 325, transmitters 330, and receivers 335 may be implemented as physically separate components that access a shared hardware resource and/or software resource, such as for example, the network interface 340.

One or more transmitters 330 and/or one or more receivers 335 may be implemented and/or integrated into a single hardware component, such as a multi-transceiver chip, a system-on-a-chip, an Application-Specific Integrated Circuit (“ASIC”), or other type of hardware component. One or more transmitters 330 and/or one or more receivers 335 may be implemented and/or integrated into a multi-chip module.

Other components such as the network interface 340 or other hardware components/circuits may be integrated with any number of transmitters 330 and/or receivers 335 into a single chip. The transmitters 330 and receivers 335 may be logically configured as a transceiver 325 that uses one more common control signals or as modular transmitters 330 and receivers 335 implemented in the same hardware chip or in a multi-chip module.

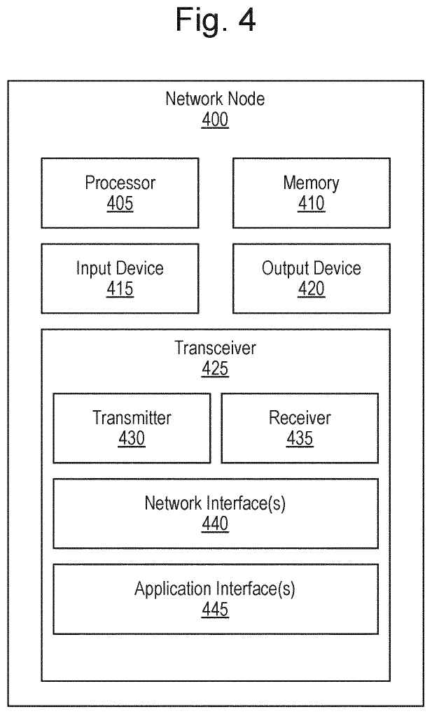

FIG. 4 depicts further details of the network node 400 that may be used for implementing the methods described herein. The network node 400 may be a base unit 104, a PLMN 230, or a PLMN 830, 930 as described herein. The network node 400 includes a processor 405, a memory 410, an input device 415, an output device 420, and a transceiver 425.

The input device 415 and the output device 420 may be combined into a single device, such as a touchscreen. In some implementations, the network node 400 does not include any input device 415 and/or output device 420. The network node 400 may include one or more of: the processor 405, the memory 410, and the transceiver 425, and may not include the input device 415 and/or the output device 420.

As depicted, the transceiver 425 includes at least one transmitter 430 and at least one receiver 435. Here, the transceiver 425 communicates with one or more remote units 200. Additionally, the transceiver 425 may support at least one network interface 440 and/or application interface 445. The application interface(s) 445 may support one or more APIs. The network interface(s) 440 may support 3GPP reference points, such as Uu, N1, N2 and N3. Other network interfaces 440 may be supported, as understood by one of ordinary skill in the art.

The processor 405 may include any known controller capable of executing computer-readable instructions and/or capable of performing logical operations. For example, the processor 405 may be a microcontroller, a microprocessor, a CPU, a GPU, an auxiliary processing unit, a FPGA, or similar programmable controller. The processor 405 may execute instructions stored in the memory 410 to perform the methods and routines described herein. The processor 405 is communicatively coupled to the memory 410, the input device 415, the output device 420, and the transceiver 425.

The memory 410 may be a computer readable storage medium. The memory 410 may include volatile computer storage media. For example, the memory 410 may include a RAM, including dynamic RAM (“DRAM”), synchronous dynamic RAM (“SDRAM”), and/or static RAM (“SRAM”). The memory 410 may include non-volatile computer storage media. For example, the memory 410 may include a hard disk drive, a flash memory, or any other suitable non-volatile computer storage device. The memory 410 may include both volatile and non-volatile computer storage media.

The memory 410 may store data related to establishing a multipath unicast link and/or mobile operation. For example, the memory 410 may store parameters, configurations, resource assignments, policies, and the like, as described herein. The memory 410 may also store program code and related data, such as an operating system or other controller algorithms operating on the network node 400.

The input device 415 may include any known computer input device including a touch panel, a button, a keyboard, a stylus, a microphone, or the like. The input device 415 may be integrated with the output device 420, for example, as a touchscreen or similar touch-sensitive display. The input device 415 may include a touchscreen such that text may be input using a virtual keyboard displayed on the touchscreen and/or by handwriting on the touchscreen. The input device 415 may include two or more different devices, such as a keyboard and a touch panel.

The output device 420 may be designed to output visual, audible, and/or haptic signals. The output device 420 may include an electronically controllable display or display device capable of outputting visual data to a user. For example, the output device 420 may include, but is not limited to, an LCD display, an LED display, an OLED display, a projector, or similar display device capable of outputting images, text, or the like to a user. As another, non-limiting, example, the output device 420 may include a wearable display separate from, but communicatively coupled to, the rest of the network node 400, such as a smart watch, smart glasses, a heads-up display, or the like. Further, the output device 420 may be a component of a smart phone, a personal digital assistant, a television, a table computer, a notebook (laptop) computer, a personal computer, a vehicle dashboard, or the like.

The output device 420 may include one or more speakers for producing sound.

For example, the output device 420 may produce an audible alert or notification (e.g., a beep or chime). The output device 420 may include one or more haptic devices for producing vibrations, motion, or other haptic feedback. All, or portions, of the output device 420 may be integrated with the input device 415. For example, the input device 415 and output device 420 may form a touchscreen or similar touch-sensitive display.

The output device 420 may be located near the input device 415.

The transceiver 425 includes at least one transmitter 430 and at least one receiver 435. The one or more transmitters 430 may be used to communicate with the UE, as described herein. Similarly, the one or more receivers 435 may be used to communicate with network functions in the PLMN and/or RAN, as described herein. Although only one transmitter 430 and one receiver 435 are illustrated, the network node 400 may have any suitable number of transmitters 430 and receivers 435. Further, the transmitter(s) 430 and the receiver(s) 435 may be any suitable type of transmitters and receivers.

Accordingly, there is provided a wireless communication device comprising a receiver arranged to receive a network information message, the network information message identifying a list of PLMNs that support Authentication with 5GC using 3GPP 5G credentials.

Such a device addresses the problem of ambiguity as to whether each PLMN in a PLMN List supports 3GPP-based authentication with EPC and/or with 5GC. This problem tends to be addressed by extending the definition of the network information such that a UE may determine whether a WLAN access network and associated PLMN supports 3GPP-based authentication with EPC and/or NSWO authentication with 5GC in a PLMN.

The network information message information so may indicate a list of PLMNs with which 3GPP-based authentication is supported, and also indicate whether 3GPP-based authentication with EPC and/or with 5GC is supported in each of those PLMNs.

The 3GPP-based authentication may comprise AAA interworking. The network information may comprise 3GPP Cellular Network Information.

The wireless communication device may further comprising a transmitter, the transmitter may be arranged to send an authentication request, the authentication request requesting a mode of authentication selected based upon the network information message.

The Authentication with 5GC using 3GPP 5G credentials may comprise Non-Seamless WLAN offload (NSWO). NSWO authentication is defined in 3GPP TS 33.501 v17.6.0, Annex S.

The wireless communication device may further comprising a processor. The processor may be arranged to: create a first list of usable PLMNs, wherein the first list includes the modes of authentication supported by each PLMN in the first list; select from the first list of usable PLMNs a first PLMN.

The modes of authentication supported by a PLMN may comprise: authenticating the wireless communication device using EPC-based authentication; and/or authenticating the wireless communication device using 5GC-based authentication.

The processor may be further arranged to: create a second list of available WLAN access networks, wherein the second list includes the modes of authentication supported by each WLAN access network; and select a first WLAN access network from the second list of available WLAN access networks.

The modes of authentication supported by a WLAN access network may comprise: authenticating the wireless communication device using EPC-based authentication; and/or authenticating the wireless communication device using 5GC-based authentication.

The processor may be further arranged to initiate an authentication procedure using the first WLAN access network and the first PLMN, wherein the mode of the authentication procedure is selected dependent upon an authentication capability of the first WLAN access network and the first PLMN.

The processor may be arranged to initiate a 5GC-based authentication procedure or an EPC-based authentication procedure using the first WLAN access network and the first PLMN, wherein the 5GC-based authentication procedure or the EPC-based authentication is selected dependent upon an authentication capability of the first WLAN access network and the first PLMN.

The authentication with EPC using 3GPP 4G credentials may comprise 3GPP-based authentication. 3GPP-based authentication is defined in TS 33.402 v17.0.0.

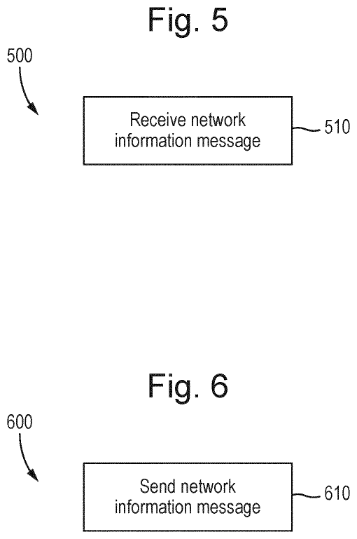

FIG. 5 illustrates a method 500 in a wireless communication device. The method 500 comprises receiving 510 a network information message, the network information message identifying a list of PLMNs that support Authentication with 5GC using 3GPP 5G credentials.

Such a process addresses the problem of ambiguity as to whether each PLMN in a PLMN List supports 3GPP-based authentication with EPC and/or with 5GC. This problem tends to be addressed by extending the definition of the network information such that a UE may determine whether a WLAN access network and associated PLMN supports 3GPP-based authentication with EPC and/or NSWO authentication with 5GC in a PLMN.

The network information message information so may indicate a list of PLMNs with which 3GPP-based authentication is supported, and also indicate whether 3GPP-based authentication with EPC and/or with 5GC is supported in each of those PLMNs.

The 3GPP-based authentication may comprise AAA interworking. The network information may comprise 3GPP Cellular Network Information.

The method may further comprise sending an authentication request, the authentication request requesting a mode of authentication selected based upon the network information message.

The Authentication with 5GC using 3GPP 5G credentials may comprise Non-Seamless WLAN offload (NSWO). NSWO authentication is defined in 3GPP TS 33.501 v17.6.0, Annex S.

The method may further comprise: creating a first list of usable PLMNs, wherein the first list includes the modes of authentication supported by each PLMN in the first list; and selecting from the first list of usable PLMNs a first PLMN.

The modes of authentication supported by a PLMN may comprise: authenticating the wireless communication device using EPC-based authentication; and/or authenticating the wireless communication device using 5GC-based authentication.

The method may further comprise: creating a second list of available WLAN access networks, wherein the second list includes the modes of authentication supported by each WLAN access network; and selecting a first WLAN access network from the second list of available WLAN access networks.

The modes of authentication supported by a WLAN access network may comprise: authenticating the wireless communication device using EPC-based authentication; and/or authenticating the wireless communication device using 5GC-based authentication.

The method may further comprise initiating an authentication procedure using the first WLAN access network and the first PLMN, wherein the mode of the authentication procedure is selected dependent upon an authentication capability of the first WLAN access network and the first PLMN.

The 5GC-based authentication procedure or an EPC-based authentication procedure may be initiated using the first WLAN access network and the first PLMN, wherein the 5GC-based authentication procedure or the EPC-based authentication is selected dependent upon an authentication capability of the first WLAN access network and the first PLMN. The authentication with EPC using 3GPP 4G credentials may comprise 3GPP-based authentication. 3GPP-based authentication is defined in TS 33.402 v17.0.0.

There is further provided a wireless communication network comprising a transmitter arranged to send a network information message, the network information message comprising a list of PLMNs that support Authentication with 5GC using 3GPP 5G credentials. The Authentication with 5GC using 3GPP 5G credentials may comprises Non-Seamless WLAN offload (NSWO). NSWO authentication is defined in 3GPP TS 33.501 v17.6.0, Annex S.

FIG. 6 illustrates a method 600 in a wireless communication network, the method comprising sending a network information message, the network information message comprising a list of PLMNs that support Authentication with 5GC using 3GPP 5G credentials. The Authentication with 5GC using 3GPP 5G credentials may comprise Non-Seamless WLAN offload (NSWO). NSWO authentication is defined in 3GPP TS 33.501 v17.6.0, Annex S.

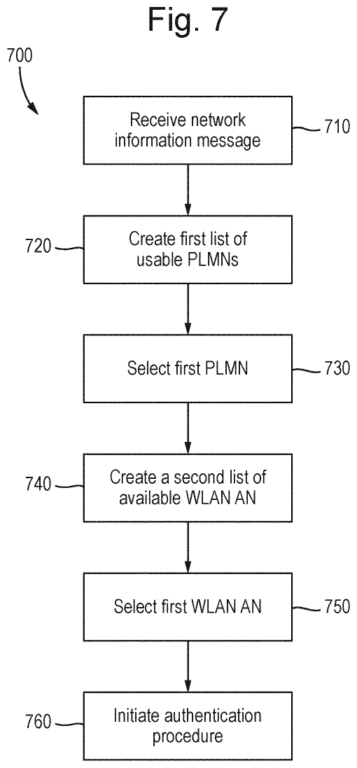

FIG. 7 illustrates a further method 700 in a wireless communication device.

The method 700 comprises: receiving 710 a network information message, the network information message identifying a list of PLMNs that support Authentication with 5GC using 3GPP 5G credentials; and creating 720 a first list of usable PLMNs, wherein the first list includes the modes of authentication supported by each PLMN in the first list The method 700 further comprises: selecting 730 from the first list of usable PLMNs a first PLMN; and creating 740 a second list of available WLAN access networks, wherein the second list includes the modes of authentication supported by each WLAN access network. The method 700 further still comprises: selecting 750 a first WLAN access network from the second list of available WLAN access networks; and initiating 760 an authentication procedure using the first WLAN access network and the first PLMN, wherein the mode of the authentication procedure is selected dependent upon an authentication capability of the first WLAN access network and the first PLMN.

There is further still provided a wireless communication device comprising a receiver a processor and a transmitter, the wireless communication device arranged to carry out the above-described method.

Such a process addresses the problem of ambiguity as to whether each PLMN in a PLMN List supports 3GPP-based authentication with EPC and/or with 5GC. This problem tends to be addressed by extending the definition of the network information such that a UE may determine whether a WLAN access network and associated PLMN supports 3GPP-based authentication with EPC and/or NSWO authentication with 5GC in a PLMN.

The network information message information so may indicate a list of PLMNs with which 3GPP-based authentication is supported, and also indicate whether 3GPP-based authentication with EPC and/or with 5GC is supported in each of those PLMNs.

The 3GPP-based authentication may comprise AAA interworking. The network information may comprise 3GPP Cellular Network Information.

The modes of authentication supported by a PLMN may comprise: authenticating the wireless communication device using EPC-based authentication; and/or authenticating the wireless communication device using 5GC-based authentication.

As explained above, in known systems the PLMN List provided by the WLAN access network contains only the list of PLMNs with which AAA interworking is supported. It does not indicate whether the AAA interworking is supported with the EPC or with the 5GC in each of these PLMNs. Known definitions of network information fail to distinguish as to whether each PLMN in the PLMN List supports AAA interworking with EPC and/or with 5GC.

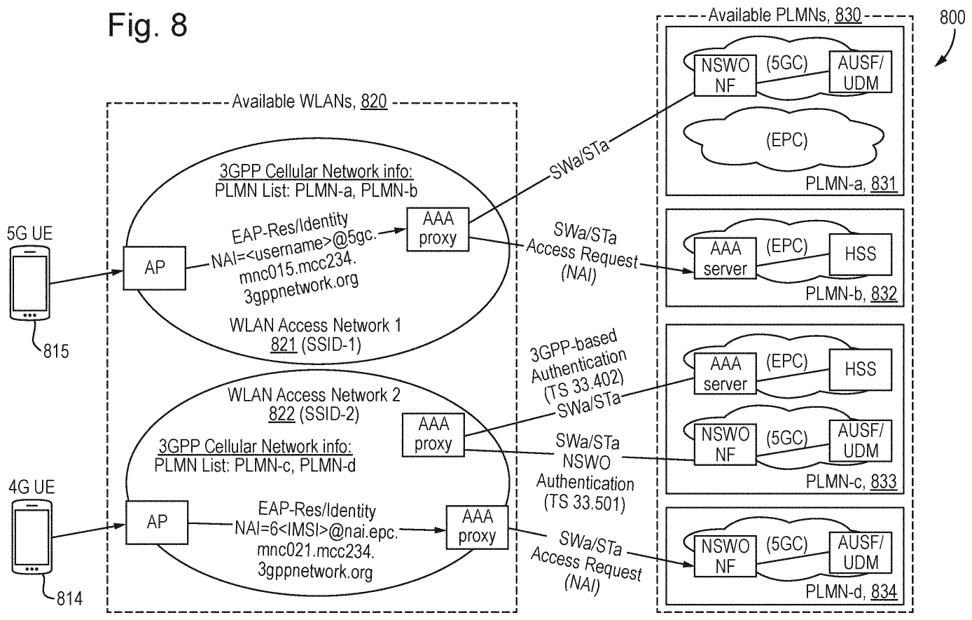

FIG. 8 illustrates a problem addressed herein by way of an example deployment scenario with two WLAN access networks, each one supporting AAA interworking with EPC and 5GC in several PLMNs. FIG. 8 illustrates a 5G UE 815, a 4G UE 814, a plurality of WLAN networks 820 and a plurality of PLMNs 830. The available WLANs 820 comprise WLAN Access Network 1 821 and WLAN Access Network 2 822. WLAN Access Network 1 821 has a first SSID, SSID-1. WLAN Access Network 2 822 which has a second SSID, SSID-2. The available PLMNs 830 comprise PLMN-a 831, PLMN-b 832, PLMN-c 833 and PLMN-d 834.

The WLAN access network 1 821 (SSID-1) supports AAA interworking with 5GC in PLMN-a 831 and with EPC in PLMN-b 832, while the WLAN access network 2 822 (SSID-2) supports AAA interworking with EPC and 5GC in PLMN-c 833 and with 5GC in PLMN-d 834. Note, however, that the PLMN List provided by the WLAN access network 821 having SSID-1 (as part of the “3GPP Cellular Network” information) contains the identity of PLMN-a 831 and PLMN-b 832 but no indication of whether AAA interworking is supported with EPC and/or 5GC in each of these PLMNs. Similarly, the PLMN List provided by the WLAN access network 822 having SSID-2 (as part of the “3GPP Cellular Network” information) contains the identity of PLMN-c 833 and PLMN-d 834 but no indication of whether AAA interworking is supported with EPC and/or 5GC in each of these PLMNs.

Since the PLMN List does not indicate whether AAA interworking is supported with EPC and/or 5GC in each of the PLMNs in this list, UEs 814, 815 lack the necessary information to determine whether they can connect to a WLAN using their 3GPP credentials. For example, the 5G UE 815 is a 5G subscriber of PLMN-b 832. This UE 815 determines that the WLAN access network 821 having SSID-1 supports AAA interworking with PLMN-b 832 and, therefore, initiates the NSWO authentication procedure specified in 3GPP TS 33.501 v17.6.0, Annex S, in order to connect to this SSID using its 3GPP credentials. As part of this procedure, the UE 815 provides a NAI including its Subscriber Concealed Identifier (NAI=SUCI=<username>@realm), which conceals the real identity of the UE 815 for privacy reasons. However, as the realm part of NAI contains the “5gc” label, the AAA proxy in the WLAN access network 1 would reject the authentication request because it does not support interworking with 5GC in PLMN-b 832. Even if the AAA proxy does not reject the authentication request, and if it sends an Access Request message to EPC in PLMN-b 832, the AAA server in PLMN-b 832 would reject this message since it does not contain an expected IMSI as part of the username. Thus, the attempt of the UE 815 to connect to WLAN access network 1 821 using its 3GPP credentials will fail.

In other words, the UE 815 knows that the WLAN access network 821 having SSID-1 supports AAA interworking with PLMN-b 832, but does not know if interworking is supported with EPC and/or with 5GC in PLMN-b 832. The UE 815 cannot use PLMN-b 832 for NSWO authentication.

The 4G UE 814 will encounter a corresponding issue. The UE 814 is a 4G subscriber of PLMN-d 834 and determines that the WLAN access network 822 having SSID-2 supports AAA interworking with PLMN-d 834. Therefore, it initiates the 3GPP-based authentication procedure specified in 3GPP TS 33.402 v17.0.0, in order to connect to WLAN access network 822 using its 3GPP credentials. As part of this procedure, the UE 814 provides a NAI including its IMSI in the username part of NAI (NAI=6<IMSI>@realm). However, as the realm part of NAI contains the “epc” label, the AAA proxy in the WLAN access network 822 would reject the authentication request because it does not support interworking with EPC in PLMN-d 834. Even if the AAA proxy does not reject the authentication request, and if it sends an Access Request message to 5GC in PLMN-d 834, the NSWOF in PLMN-d 834 would reject this message since it does not contain an expected SUCI. Thus, the attempt of the UE 814 to connect to WLAN access network 822 using its 3GPP credentials will fail.

In other words, the UE 814 knows that the WLAN access network 822 SSID-2 supports AAA interworking with PLMN-d 834, but does not know if interworking is supported with EPC and/or with 5GC in PLMN-d 834. The UE 814 cannot use PLMN-d 834 for 3GPP-based authentication.

There is presented herein an arrangement that addresses the above identified issue by extending the definition of “3GPP Cellular Network” information and by enabling UEs to determine which mode of authentication is supported by a WLAN access network. That is, whether a WLAN access network supports 3GPP-based authentication (or AAA interworking) with EPC and/or NSWO authentication with 5GC in a PLMN.

Specific examples are given herein with reference to 3GPP-based authentication (or AAA interworking) with EPC and/or NSWO authentication with 5GC in a PLMN. However, it should be noted that the concepts presented herein may be applied in any wireless communication network where different modes of authentication are available. For the examples given herein, it may be noted that authentication with EPC using 3GPP 4G credentials is called 3GPP-based authentication and is defined in 3GPP TS 33.402 v17.0.0, while the authentication with 5GC using 3GPP 5G credentials is called NSWO authentication and is defined in 3GPP TS 33.501 v17.6.0, Annex S.

As presented herein, the definition of “3GPP Cellular Network” information is extended to include, not only a list of PLMNs with which AAA interworking is supported, but also indicate which mode of authentication is supported by each PLMN. Specifically, that may be whether AAA interworking with EPC and/or with 5GC is supported in each of these PLMNs.

Presently, the “3GPP Cellular Network” information, as defined in 3GPP TS 24.302 v17.0.0, Annex H, can contain one or more of the following lists:
PLMN List: Contains a list of PLMNs with which the WLAN supports AAA interworking (but without indicating whether interworking is supported with EPC and/or 5GC).
PLMN List with S2a connectivity: Contains a list of PLMNs with which the WLAN supports S2a connectivity to EPC.
PLMN List with trusted 5G connectivity: Contains a list of PLMNs with which the WLAN supports 5G connectivity to 5GC.
PLMN List with trusted 5G connectivity-without-NAS: Contains a list of PLMNs with which the WLAN supports 5G connectivity-without-NAS to 5GC.

Instead of extending the above PLMN List, which would create backwards compatibility issues (i.e., it wouldn't be parseable by existing UEs), we introduce an additional list:
PLMN List with AAA connectivity to 5GC: Contains a list of PLMNs with which the WLAN supports AAA connectivity to 5GC, i.e., it supports 5G NSWO with these PLMNs.

The existing PLMN List (bullet 1 of the above list reproduced from 3GPP TS 24.302 v17.0.0, Annex H) is then used only to include the PLMNs with which the WLAN supports AAA interworking with EPC (or 3GPP-based authentication).

As an example, the WLAN access network 821 with SSID-1 in FIG. 8 would provide the following PLMN lists in network information:
PLMN List: PLMN-b
PLMN List with AAA connectivity to 5GC: PLMN-a

Similarly, the WLAN access network 822 with SSID-2 in FIG. 8 would provide the following PLMN lists in network information:
PLMN List: PLMN-c
PLMN List with AAA connectivity to 5GC: PLMN-c, PLMN-d

The WLAN selection method presented below uses the enhanced “3GPP Cellular Network” information specified above. It is used by a 5G UE for selecting a WLAN access network to connect to and a PLMN to be used for the authentication.

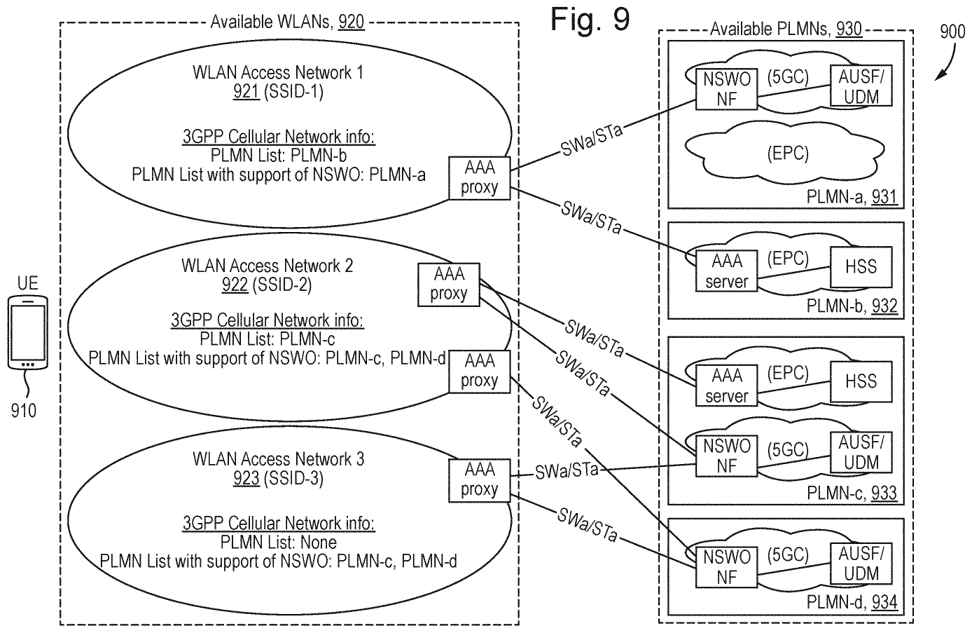

FIG. 9 illustrates a deployment scenario using the network information described herein. FIG. 9 illustrates a UE 910, a plurality of WLAN networks 920 and a plurality of PLMNs 930. The available WLANs 920 comprise WLAN Access Network 1 921, WLAN Access Network 2 922 and WLAN Access Network 3 923. WLAN Access Network 1 921 has a first SSID, SSID-1. WLAN Access Network 2 922 has a second SSID, SSID-2. WLAN Access Network 3 923 has a third SSID, SSID-3. The available PLMNs 930 comprise PLMN-a 931, PLMN-b 932, PLMN-c 933 and PLMN-d 934. Note that the interface used to connect a WLAN access network with a AAA server in EPC and the interface used to connect a WLAN access network with a NSWO NF in 5GC are the same (SWa/STa), i.e., they use the same procedures and protocols. Nevertheless, the 3GPP-based authentication between the UE and EPC, and the NSWO authentication between the UE and 5GC have some notable differences, including the value of NAI provided by the UE 910. Note also that the AAA servers in FIG. 9 may be AAA proxies, if they are deployed in a PLMN 930, other than the HPLMN of the UE 910.

At step 0, the UE decides to connect to a WLAN access network using its 3GPP credentials. This may be decided e.g., when the user activates the WLAN radio interface, or when the UE applies a URSP rule which indicates that some data traffic should be offloaded to WLAN access, or for any other implementation-dependent reason.

At step 1, the UE 910 discovers the available WLANs and, for each WLAN, it identifies: the PLMNs with which “AAA connectivity to EPC” is supported; and the PLMNs with which “AAA connectivity to 5GC” is supported.

The PLMNs 930 with which AAA connectivity to EPC is supported are also the PLMNs with which 3GPP-based authentication (as defined in 3GPP TS 33.402 v17.0.0) is supported. Similarly, the PLMNs 930 with which AAA connectivity to 5GC is supported are also the PLMNs with which NSWO authentication (as defined in 3GPP TS 33.501 v17.6.0) is supported.

The UE 910 identifies the above PLMNs by sending an ANQP request message to each WLAN 920 requesting “3GPP Cellular Network” information and receiving an ANQP response message containing “3GPP Cellular Network” information. The “3GPP Cellular Network” information in the ANQP response contains one or more of the following PLMN lists:
PLMN List
PLMN List with S2a connectivity
PLMN List with trusted 5G connectivity
PLMN List with trusted 5G connectivity-without-NAS
PLMN List with AAA connectivity to 5GC

The contents of the “PLMN List” indicate the PLMNs with which AAA connectivity to EPC is supported, and the contents of the “PLMN List with AAA connectivity to 5GC” indicate the PLMNs with which AAA connectivity to 5GC is supported.

It should be noted that when a WLAN supports AAA connectivity to 5GC of a PLMN, this means that the WLAN supports 5GC-based authentication with this PLMN. Hence, the terms “AAA connectivity to 5GC” and “5GC-based authentication” are used interchangeably and have the same meaning. The same is true with the terms the terms “AAA connectivity to EPC” and “EPC-based authentication”.

In the example shown in FIG. 9, the UE 910 discovers the following three WLANs 920 and identifies the authentication modes supported by each PLMN as listed in table 1 below.

TABLE 1
An example of PLMN authentication modes discovered by a UE.

| WLAN access | PLMNs which support | PLMNs which support |
|---|---|---|
| network SSID | AAA connectivity to EPC | AAA connectivity to 5GC |
| SSID-1 | PLMN-b | PLMN-a |
| SSID-2 | PLMN-c | PLMN-c, PLMN-d |
| SSID-3 | None | PLMN-c, PLMN-d |

At step 2, the UE 910 creates a first list of usable PLMNs, i.e., a list of PLMNs which can be used to authenticate the UE 910, either using the 3GPP-based authentication procedure supported by EPC, or the NSWO authentication procedure supported by 5GC. The first list of usable PLMNs is typically a subset of the available PLMNs, i.e., of all PLMNs with which AAA connectivity is supported by any of the available WLANs. In the above example, the available PLMNs are PLMN-a 931, PLMN-b 932, PLMN-c 933, and PLMN-d 934.

An available PLMN is “usable” for the UE 910 (i.e., can be used to authenticate the UE 910) when (a) it is the HPLMN of the UE 910, or (b) it is a PLMN equivalent with the HPLMN, or (c) it is a PLMN which supports roaming with the HPLMN. The UE 910 can identify whether a PLMN is “usable” by employing information stored in the USIM module and other information local in the UE 910. As an example, the UE 910 determines that the first list of usable PLMNs contains:
First list of usable PLMNs=PLMN-a 931, PLMN-b 932, and PLMN-c 933.

The PLMN-d 934 is excluded from the first list of usable PLMNs, e.g., because it is not the HPLMN or a PLMN equivalent with the HPLMN and it does not support roaming with the HPLMN. Hence, it cannot be used to authenticate the UE 910.

At step 3, from the first list of usable PLMNs, the UE 910 selects a first PLMN, which will be used to authenticate the UE 910. The first PLMN can be selected as follows:
If the first list of usable PLMNs contains the HPLMN, the UE 910 selects the HPLMN.
Otherwise, if the first list of usable PLMNs contains a PLMN equivalent with the HPLMN, the UE 910 selects this PLMN.
Otherwise, the UE 910 selects the PLMN that has the highest priority in the Operator Controlled PLMN Selector list configured in the USIM module.

In the example above, it is assumed that the UE 910 selects the PLMN-c 933 as the first PLMN.

At step 4, the UE 910 creates a second list of WLANs that contains the WLANs which support AAA connectivity to 5GC with the first (selected) PLMN. If no WLAN supports AAA connectivity to 5GC with the first PLMN, then the second list of WLANs contains the WLANs which support AAA connectivity to EPC with the first PLMN. In the example above, the second list of WLANs contains:
Second list of WLANs: SSID-2, SSID-3

At step 5, the UE 910 selects a WLAN from the second list of WLANs. If the second list of WLAN contains more than one WLAN, the UE 910 selects one of them, either using implementation-based criteria, or using the WLAN Selection Policy of the first PLMN, if such policy exists in the UE 910.

At step 6, if the selected WLAN supports AAA connectivity to 5GC with the first (selected) PLMN, the UE 910 initiates a NSWO authentication procedure using the selected WLAN and 5GC in the first (selected) PLMN. Otherwise, the UE 910 initiates a 3GPP-based authentication procedure using the selected WLAN and EPC in the first (selected) PLMN.

After the successful authentication procedure, the UE is connected to the selected WLAN using the AAA services provided by EPC or 5GC in the first PLMN.

The above described method may be applied by a UE which determines a need to select a WLAN and a PLMN for initiating either 5GC-based authentication or EPC-based authentication

There is further provided an alternative and simplified method which may be applied by a UE that wants to select a WLAN and a PLMN for initiating 5GC-based authentication (5G NSWO).

A WLAN access network may also advertise the following PLMN list:
PLMN List with AAA connectivity to 5GC: which includes PLMNs with which “AAA connectivity to 5GC”. A WLAN access network supports “AAA connectivity to 5GC” in a PLMN when it deploys an AAA function that can connect with a NSWOF in this PLMN. The NSWOF supports “WLAN connection using 5G credentials without 5GS registration”.

It should be noted that “PLMN List with AAA connectivity to 5GC” may also be referred to as “PLMN List-5”; the latter term used in, for example, 3GPP TS 23.501 v17.6.0.

When the UE determines a need to connect to a WLAN access network using the “WLAN connection using 5G credentials without 5GS registration” procedure, the UE executes the following steps:

At step 1, the UE constructs a list of available PLMNs with which “AAA connectivity to 5GC” is supported. This list contains the PLMNs included in the PLMN List-5 advertised by all discovered WLAN access networks.

At step 2, the UE selects a PLMN from the list of available PLMNs. The selected PLMN shall be able to authenticate the UE using 5G credentials, e.g., it could be the HPLMN, a PLMN equivalent to the HPLMN, or another PLMN. How the UE selects this PLMN depends on the UE implementation.

At step 3, the UE creates a list of WLANs that support “AAA connectivity to 5GC” with the selected PLMN.

At step 4, the UE selects a WLAN from the above list of WLANs. If there are multiple WLANs that support “AAA connectivity to 5GC” with the selected PLMN, the UE selects one of them, either using implementation-based criteria, or using the WLAN Selection Policy (WLANSP) of the selected PLMN, if such policy exists in the UE.

At step 5, the UE initiates the “WLAN connection using 5G credentials without 5GS registration” procedure using the selected WLAN and the selected PLMN.

There is further provided an apparatus (such as a UE) comprising a transceiver and a processor. The transceiver is configured to communicate with one or more WLAN access networks. The processor is coupled to the transceiver, and the processor is configured to cause the apparatus to: discover the available WLANs; identify, for each available WLAN, the PLMNs with which EPC-based authentication is supported and the PLMNs with which 5GC-based authentication is supported; select from the first list of usable PLMNs a first PLMN; create a second list of available WLAN access networks, the second list containing all available WLAN access networks that support 5GC-based authentication with the first PLMN or EPC-based authentication with the first PLMN; select a first WLAN access network from the second list of available WLAN access networks; and initiate a 5GC-based authentication procedure or an EPC-based authentication procedure using the first WLAN access network and the first PLMN.

The processor may be arranged to identify, for each available WLAN, the PLMNs with which EPC-based authentication is supported and the PLMNs with which 5GC-based authentication is supported, by using the extensions to the “3GPP Cellular Network” information described herein.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
receive a network information message, the network information message identifying a list of public land mobile networks (PLMNs) that support authentication with fifth generation (5G) core (5GC) using 3GPP 5G credentials.

2. The UE of claim 1, wherein the at least one processor is configured to cause the UE to send an authentication request, the authentication request requesting a mode of authentication selected based at least in part on the network information message.

3. The UE of claim 1, wherein the authentication with the 5GC using 3GPP 5G credentials comprises non-seamless wireless local area network (WLAN) offload (NSWO).

4. The UE of claim 1, wherein the at least one processor is configured to cause the UE to:
create a first list of usable PLMNs, wherein the first list includes modes of authentication supported by each PLMN in the first list; and
select a first PLMN from the first list of usable PLMNs.

5. The UE of claim 4, wherein the at least one processor is configured to cause the UE to:
create a second list of available wireless local area network (WLAN) access networks, wherein the second list includes the modes of authentication supported by each WLAN access network; and
select a first WLAN access network from the second list of available WLAN access networks.

6. The UE of claim 5, wherein the at least one processor is configured to cause the UE to:
initiate an authentication procedure using the first WLAN access network and the first PLMN, wherein a mode of the authentication procedure is selected based at least in part on an authentication capability of the first WLAN access network and the first PLMN.

7. The UE of claim 1, wherein authentication with an evoked packet core (EPC) using 3GPP fourth generation (4G) credentials comprises 3GPP-based authentication.

8. A method performed by a user equipment (UE), the method comprising:
receiving a network information message, the network information message identifying a list of public land mobile networks (PLMNs) that support authentication with fifth generation (5G) core (5GC) using 3GPP 5G credentials.

9. The method of claim 8, further comprising sending an authentication request, the authentication request requesting a mode of authentication selected based at least in part on the network information message.

10. The method of claim 8, wherein the authentication with the 5GC using 3GPP 5G credentials comprises non-seamless wireless local area network (WLAN) offload (NSWO).

11. The method of claim 8, further comprising:
creating a first list of usable PLMNs, wherein the first list includes modes of authentication supported by each PLMN in the first list; and
selecting a first PLMN from the first list of usable PLMNs.

12. The method of claim 11, further comprising:
creating a second list of available wireless local area network (WLAN) access networks, wherein the second list includes the modes of authentication supported by each WLAN access network; and
selecting a first WLAN access network from the second list of available WLAN access networks.

13. The method of claim 12, further comprising initiating an authentication procedure using the first WLAN access network and the first PLMN, wherein a mode of the authentication procedure is selected based at least in part on an authentication capability of the first WLAN access network and the first PLMN.

14. The method of claim 8, wherein authentication with an evoked packet core (EPC) using 3GPP fourth generation (4G) credentials comprises 3GPP-based authentication.

15. A network node for wireless communication, comprising:
at least one memory; and
at least one processor coupled with the at least one memory and configured to cause the network node to:
send a network information message, the network information message comprising a list of public land mobile networks (PLMNs) that support authentication with fifth generation (5G) core (5GC) using 3GPP 5G credentials.

16. The network node of claim 15, wherein the authentication with the 5GC using 3GPP 5G credentials comprises non-seamless wireless local area network (WLAN) offload (NSWO).

17. A method performed by a network node, the method comprising:
sending a network information message, the network information message comprising a list of public land mobile networks (PLMNs) that support authentication with fifth generation (5G) core (5GC) using 3GPP 5G credentials.

18. The method of claim 17, wherein the authentication with the 5GC using 3GPP 5G credentials comprises non-seamless wireless local area network (WLAN) offload (NSWO).

19. The method of claim 17, further comprising receiving an authentication request, the authentication request requesting a mode of authentication selected based at least in part on the network information message.

20. The network node of claim 15, wherein the at least one processor is configured to cause the network node to receive an authentication request, the authentication request requesting a mode of authentication selected based at least in part on the network information message.
